(19) United States
(12) Patent Application Publication
(10) Pub. No.: US 2012/0043729 A1
(43) Pub. Date: Feb. 23, 2012

(54) CARRIAGE SEALING STRUCTURE FOR REFRIGERATOR CAR AND WORKING METHOD THEREOF

(76) Inventor: Hong Wang, Guangzhou (CN)

(21) Appl. No.: 13/262,236

(22) PCT Filed: Dec. 30, 2009
(86) PCT No.: PCT/CN2009/076275

§ 371 Date: Oct. 26, 2011

(30) Foreign Application Priority Data
Apr. 3, 2009 (CN) 2009100383794

(51) Int. Cl. F16J 15/02; B62D 33/04; B23P 17/00

(52) U.S. Cl. 277/641; 29/527.1

(57) ABSTRACT

A carriage sealing structure for refrigerator car is disclosed. The carriage is composed of core carriage plates provided with a heat preservation layer that is made of polyurethane. The carriage plates include a left side plate (5), a right side plate (6), a head plate (1), a soleplate (3), a front plate (4) and a backdoor plate (2). Notches are equipped at the jointed sites of the left side Plate, the right side plate, the head plate, the soleplate and the front plate, and an injection groove (7) is formed by the notches between mutually jointed carriage plates. High density polyurethane foam material is filled in the injection grooves in a high pressure so as to provide sealed connection between carriage plates. A working method for the carriage sealing structure is also disclosed. Assembled refrigerator car carriage is simple in structure and better in connection strength of the carriage plates. The structure can effectively reduce the cold air leakage or cold energy conduction of the carriage to improve the thermal insulation property of the carriage.

### FIELD OF THE INVENTION

The invention relates to a carriage for refrigeration car, and particularly relates to a carriage sealing structure for refrigerator car and working method thereof.

### BACKGROUND OF THE INVENTION

At present, a typical carriage for refrigerator car in domestic market is mainly assembled by a plurality of carriage plates with a sandwich style assembly mode. A refrigerator car comprises a left side plate, a right side plate, a head plate, a soleplate and a front plate which are fastened by bolts or adhesive glue of high-strength structural and aluminum rivets. The joint styles ensure that every plate can form reliable connection and better in connection strength. But there is no special treatment at the joint sites among plates, then much thermal convection will be produced inside the gaps between the plates. With wrong handling, it would appear gaps which inside and outside unicorn, and form an air leakage channel, more serious, it would cause cold energy loss, and then influence the thermal insulation performance of the carriage.

### SUMMARY OF THE INVENTION

The present invention is to provide a carriage sealing structure for refrigerator car and working method thereof, to make the structure simplified and easy to manufacture, and effectively reduce the cold air leakage or cold energy conduction.

To solve the above-mentioned problems, one technical solution of the present invention is: a refrigerator car comprises a carriage sealing structure for refrigerator car, the carriage is composed of core carriage plates provided with a heat preservation layer that is made of polyurethane. The carriage plates include a left side plate, a right side plate, a head plate, a soleplate, a front plate and a backdoor plate. Notches are equipped at the jointed sites of the left side plate, the right side plate, the head plate, the soleplate and/or the front plate.

An injection groove is formed by the notches between the left side plate and the soleplate, and an injection groove is formed by the notches between the left side plate and the head plate, and an injection groove is formed by the notches between the left side plate and the front plate; and an injection groove is formed by the notches between the right side plate and the soleplate, and an injection groove is formed by the notches between the right side plate and the head plate, and an injection groove is formed by the notches between the right side plate and the front plate; and an injection groove is formed by the notches between the head plate and the front plate, and an injection groove is formed by the notches between the soleplate and the front plate. High density polyurethane foam material is filled in the injection grooves.

Injection grooves are equipped at the jointed sites between the left side plate, the right side plate, the head plate, the soleplate and/or the front plate. This is equal to add a transition zone among carriage plates. Filling material in the transition zone could connect the spliced carriage plates together. The carriage sealing structure for refrigerator car of the invention takes advantage of high-density polyurethane material the same with the carriage plates as filling material. After filling the injection grooves with polyurethane, the spliced carriage plates are connected as a whole carriage sealing structure because of good thermal insulation and adhesion of high-density polyurethane material. Therefore, the carriage is simple in structure, sealing well, so that hardly cause the cold air leakage among plates.

As another preferred embodiment of the present invention, an inner overlockings are equipped at the jointed sites of the left side plate, the right side plate, the head plate, the soleplate and/or the front plate. The connection between the carriage plates could be further reinforced by inner overlockings.

As another preferred embodiment of the present invention, an external overlockings are equipped at the jointed sites of the left side plate, the right side plate, the head plate, the soleplate and/or the front plate. The connection between the carriage plates could be further reinforced by external overlockings.

As another preferred embodiment of the present invention, the inner overlockings and the external overlockings are connected and fasten to the carriage plate with the bolts or rivets and so on.

The other technical solution of the present invention is: A working method for the carriage sealing structure of the present invention comprises the following steps:

Step A. Cutting out the notches at the jointed sites of the left side plate, the right side plate, the head plate, the soleplate and/or the front plate of the carriage, or forming the notches directly when the left side plate, the right side plate, and the head plate being foaming;

Step B. Assembling the left side plate, the right side plate, the head plate, the soleplate and the front plate together to form a carriage without backdoor plate, and assembling a backdoor frame at the back of the carriage;

Step C. First filling the polyurethane material into the injection grooves in the horizontal direction;

Step D. Then filling the polyurethane material into the injection grooves in the vertical direction; and

Step E. Installing the backdoor plate to the backdoor frame.

As another preferred embodiment of the present invention, in step C) further comprises the following steps:

Step C1) Filling the polyurethane material into the injection groove formed by the notch equipped at the jointed sites of the left side plate and the soleplate;

Step C2) Filling the polyurethane material into the injection groove formed by the notch equipped at the jointed sites of the left side plate and the head plate;

Step C3) Filling the polyurethane material into the injection groove formed by the notch equipped at the jointed sites of the right side plate and the soleplate;

Step C4) Filling the polyurethane material into the injection groove formed by the notch equipped at the jointed sites of the right side plate and the head plate;

Step C5) Filling the polyurethane material into the injection groove formed by the notch equipped at the jointed sites of the head side plate and the front side plate; and/or

Step C6) Filling the polyurethane material into the injection groove formed by the notch equipped at the jointed sites of the soleplate and the front side plate.

As another preferred embodiment of the present invention, in step D) further comprises the following steps:

Step D1) Filling the polyurethane material into the injection groove formed by the notch equipped at the jointed sites of the left side plate and the front side plate; and/or

Step D2) Filling the polyurethane material into the injection groove formed by the notch equipped at the jointed sites of the right side plate and the front side plate.

The injection grooves are simple in structure, easy to operate. After filling in a high pressure condition, the injection grooves are full of polyurethane material. In the foaming process, on the one hand, with the expanding of polyurethane, the gaps between the carriage plates are full of polyurethane material and the fastened rivets are expanded in the gaps, so that cut off the air leak channel, and on the another hand because of good thermal insulation and adhesion of polyurethane material, the carriage is better in sealing and insulation after filling.

As another preferred embodiment of the present invention, in step B, after assembling the carriage, adding inner overlockings and/or external overlockings at the jointed sites of the left side plate, the head plate and the soleplate; adding inner overlockings and/or external overlockings at the jointed sites of the right side plate, the head plate and the soleplate; adding inner overlockings and/or external overlockings at the jointed sites of the front plate, the head plate and the soleplate; adding overlockings to the carriage plates is not only strengthen the connection among the carriage plates, but also prevent sealing structure from damaged by the expansion of polyurethane.

As another preferred embodiment of the present invention, after step C, adding inner overlockings and/or external overlockings at the jointed sites of the front plate, the left side plate and the right side plate. Adding overlockings to the carriage plates is not only strengthen the connection among the carriage plates, but also prevent sealing structure from damaged by the expansion of polyurethane in the injection grooves.

As another preferred embodiment of the present invention, the overlockings are made of Aluminum. The inner overlockings and/or the external overlockings are fixed onto the left side plate, the right side plate, the head plate, the soleplate and/or the front plate with bolts or rivets and so on, so as to strengthen the connection among the carriage plates further.

As another preferred embodiment of the present invention, in step C and D, high density polyurethane foam material is filled in the injection grooves in a high pressure condition. Compared to the common polyurethane material, it is better in thermal insulation and adhesion, the polyurethane foam material would be connecting better with the carriage plates, eliminate the gap between the carriage plates completely, by filling in the injection grooves in a high pressure condition.

Compared to prior art, the present invention has the following advantages:

In the structure of the carriage sealing, the refrigerator car carriage is simple in structure, the inner overlockings and/or the external overlockings are used to fixed at the jointed sites of the carriage plates. The gaps between the jointed sites are completely filling with polyurethane materials, so that there is no gap between thermal insulation layer and cut off the air leak channel at the jointed sites, accordingly, it effectively reduce the cold energy conduction to improve the sealing and insulation property of the carriage.

In manufacturing process, the injection grooves also are simple in structure, they can mold directly on the carriage plates foaming, no extra process, injection process is simple and fast. With good adhesion of polyurethane, the carriage plates are connecting with each other, and the rivets are fastened inner, so as to improve the stiffness and bonding strength of the whole carriage.

### DESCRIPTION OF THE DRAWINGS

FIG. 1 is a perspective view of the refrigerator car of the present invention;

FIG. 2 is a three dimensional view of the refrigerator car of the present invention;

FIG. 3 is a cross-sectional view of the refrigerator car of the present invention;

FIG. 4 is a lengthwise sectional view of the refrigerator car of the present invention;

FIG. 5 is a sectional view of the refrigerator car of the A-A in FIG. 2;

FIG. 6 is a sectional view of the refrigerator car of the B-B in FIG. 2;

FIG. 7 is a sectional view of the refrigerator car of the C-C in FIG. 2; and

FIG. 8 is a flow diagram of sealing structure of the refrigerator car of the present invention.

### DETAILED DESCRIPTION OF THE INVENTION

Illustrate the present invention further with drawings as follows:

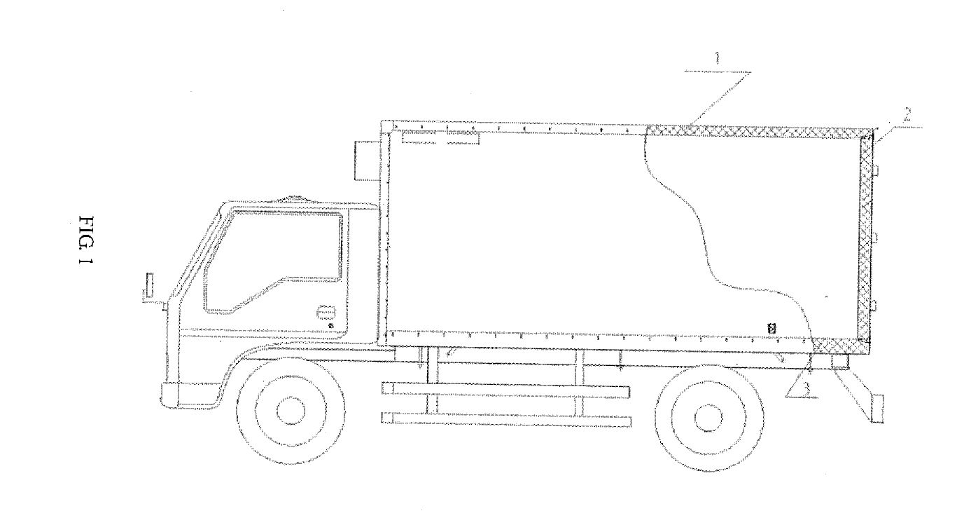

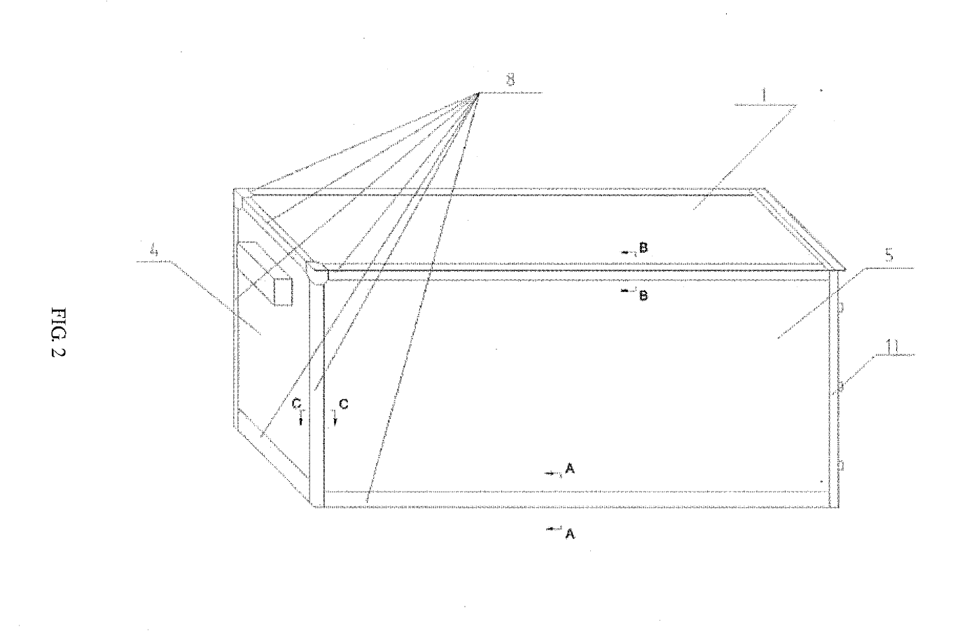

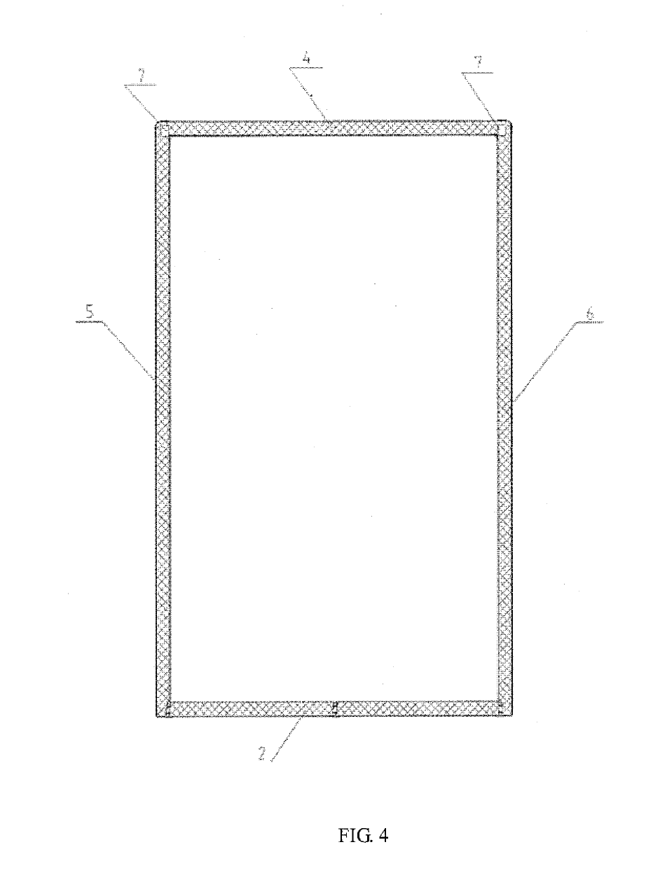

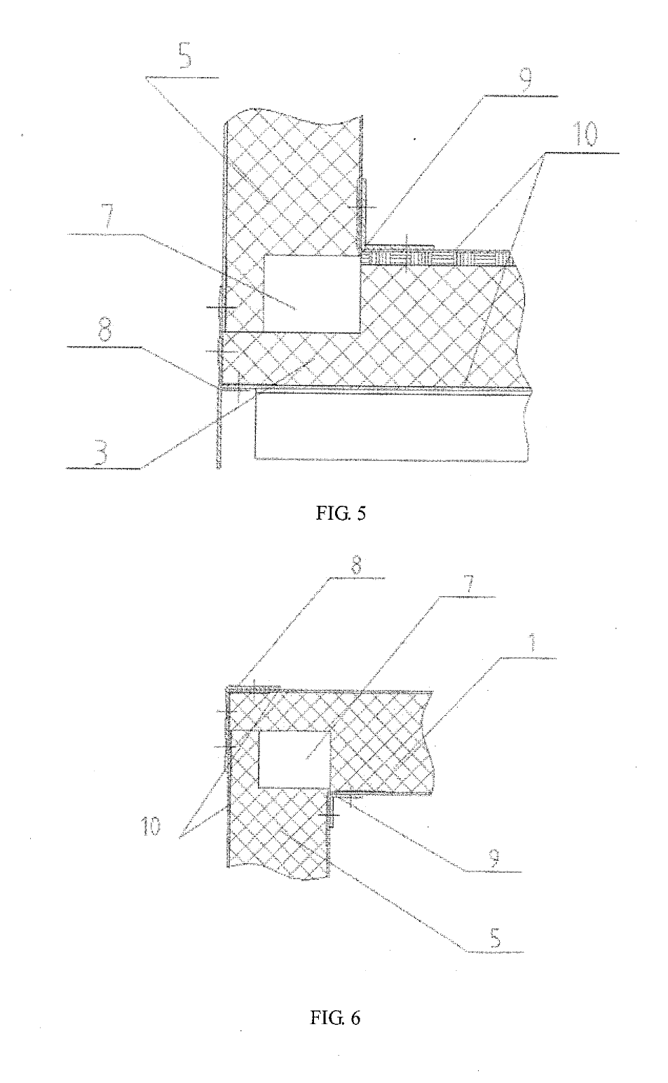

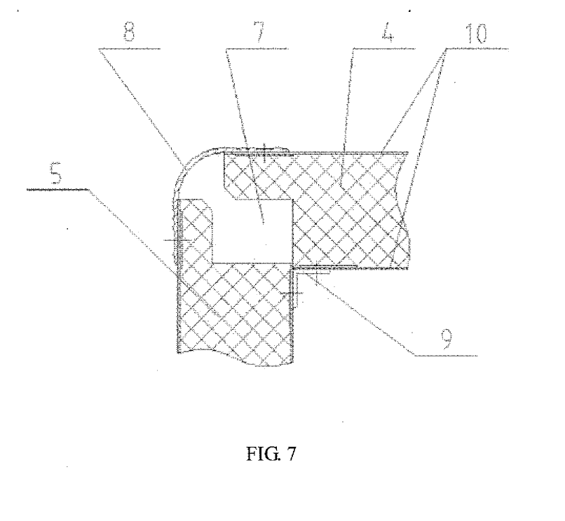

Referring to FIGS. 1 to 7, A carriage of the first embodiment of the present invention comprises a plurality of core carriage plates provided with a heat preservation layer that is made of polyurethane. Both sides of the plates are glass Plates 10, and the polyurethane are filled inside thereof .

The carriage plates comprise a head plate 1, a backdoor plate 2, a soleplate 3, a front plate 4, a left side plate 5 and a right side plate 6. Notches are equipped at the jointed sites of the head plate 1, the soleplate 3, the front plate 4, the left side plate 5 and/or the right side plate 6.

An injection groove 7 is formed by the notches between the carriage plates. Such as, the notches between the left side plate 5 and the soleplate 3; the notches between the left side plate 5 and the head plate 1; the notches between the left side plate 5 and the front plate 4; the notches between the right side plate 6 and the soleplate 3; the notches between the right side plate 6 and the head plate 1; the notches between the right side plate 6 and the front plate 4; the notches between the head plate 1 and the front plate 4; the notches between the soleplate 3 and the front plate 4, and so on. High density polyurethane foam material is filled in the injection grooves 7.

An inner overlockings 9 and an external overlockings 8 are respectively equipped at the jointed sites of the head plate 1, the soleplate 3, the front plate 4, the left side plate 5 or the right side plate 6. The inner overlockings 9 are located inside of the jointed sites of the carriage plates. External overlockings 8 are located outside of the jointed sites of the carriage plates. The inner overlockings 9 and the external overlockings 8 are mounted on the plates with rivets or other installation parts. All carriage plates are assembled together to build a whole carriage.

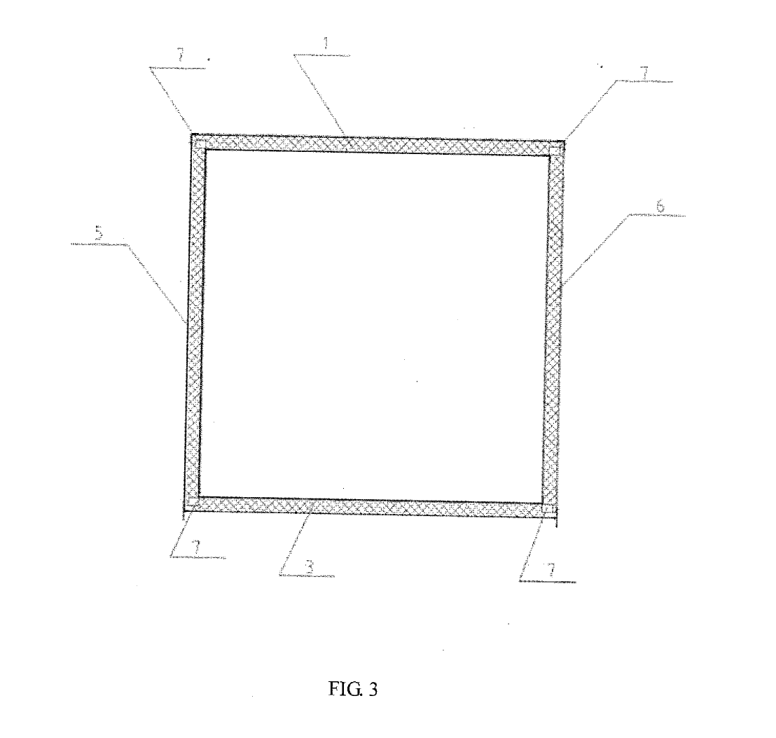

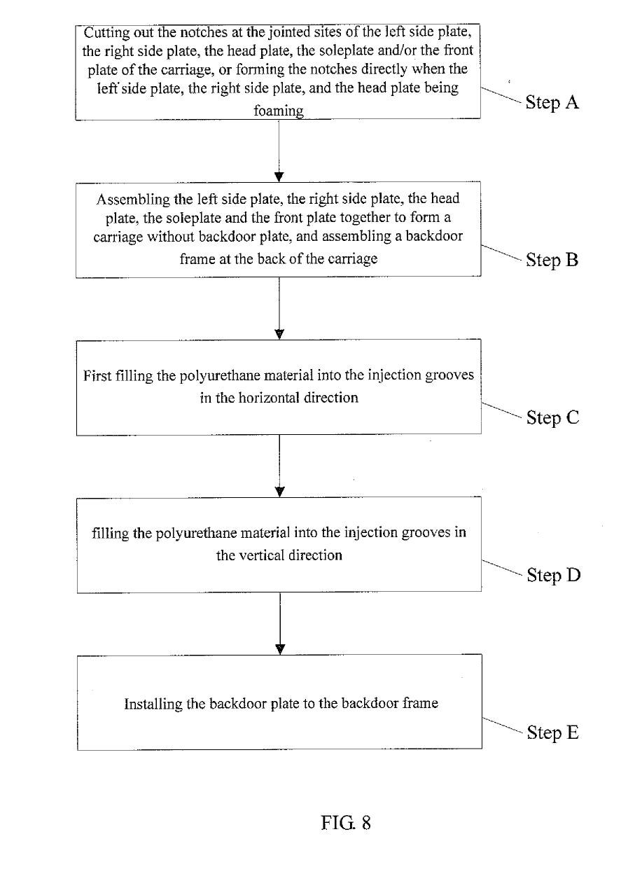

Referring to FIGS. 3 to 8, a working method for the carriage sealing structure of the second embodiment of the present invention comprises the steps as follows:

Step A. Cutting out the notches at the jointed sites of the head plate 1, the soleplate 3, the front plate 4, the left side plate 5 and/or the right side plate 6, or forming the notches directly when the head plate 1, the soleplate 3, the front plate 4, the left side plate 5, and the right side plate 6 being foaming;

Step B. Assembling the head plate 1, the soleplate 3, the front plate 4, the left side plate 5 and/or the right side plate 6 together to form a carriage without backdoor plate, then assembling a backdoor frame at the back of the carriage. After assembling the carriage, add inner overlockings 9 and external overlockings 8 at the jointed sites of the left side plate 5, the head plate 1 and the soleplate 3; add inner overlockings and external overlockings 8 at the jointed sites of the right side plate 6, the head plate 1 and the soleplate 3; add inner overlockings 9 and external overlockings 8 at the jointed sites of the front plate 4, the head plate land the soleplate 3.

Step C. Filling the injection grooves in the horizontal direction, as following:

Step C1. Filling the polyurethane foam material in a high pressure in the both end of the injection groove 7 formed by the notch equipped at the jointed sites of the left side plate 5 and the soleplate 3;

Step C2. Filling the polyurethane foam material in a high pressure in the both end of the injection groove 7 formed by the notch equipped at the jointed sites of the left side plate 5 and the head plate 1.

Step C3. Filling the polyurethane foam material in a high pressure in the both end of the injection groove 7 formed by the notch equipped at the jointed sites of the right side plate 6 and the soleplate 3;

Step C4. Filling the polyurethane foam material in a high pressure in the both end of the injection groove 7 formed by the notch equipped at the jointed sites of the right side plate 6 and the head plate 1;

Step C5. Filling the polyurethane foam material in a high pressure in the both end of the injection groove 7 formed by the notch equipped at the jointed sites of the front side plate 4 and the head plate 1; and/or

Step C6. Filling the polyurethane foam material in a high pressure in the both end of the injection groove 7 formed by the notch equipped at the jointed sites of the soleplate 3 and the front plate 4;

Step D. Then filling the injection grooves 7 in the vertical direction, before filling, adding the inner overlockings 9 and the external overlockings 8 at the jointed sites of the front plate 4, the left side plate 5 and the right side plate 6; as following:

Step D1 Filling the polyurethane foam material in a high pressure at the top of the injection groove 7 formed by the notch equipped at the jointed sites of the left side plate 5 and the front plate 4; and/or

Step D2. Filling the polyurethane foam material in a high pressure at the top of the injection groove 7 formed by the notch equipped at the jointed sites of the right side plate 5 and the front plate 4;

Step E. Installing the backdoor plate to the backdoor frame 11.

Using the inner overlockings and the external overlocking to bond with each carriage plate to make them more close and stabled. In the whole carriage frame, the backdoor frame 11 is used as a size limit to prevent the whole carriage structure from damaged by the expansion of the foaming polyurethane in the injection grooves 7.

The shape of the notches are rectangle in the embodiment of the invention, they can also be triangle, arch, diamond et al. All changes belong to the scope of the protection when they are just change the form of the present invention.

The present invention is simple in structure, the injection grooves 7 could mold directly when the carriage plates foaming, no extra process. The jointed site are completely filled with polyurethane materials, connecting with each carriage without gaps, cutting off the air leak channel at the jointed sites, so as to effectively reduce the cold energy conduction, improve the insulation property of the carriage. It is simple in manufacturing process, the jointed site are completely filled in high pressure, With good adhesion of the polyurethane, it connects the carriage plates together and the rivets without loose, so as to improve the stiffness and bonding strength of the whole carriage.

What is claimed is:

1. A carriage sealing structure for refrigerator car, the carriage comprises core carriage plates provided with a heat preservation layer that is made of polyurethane, the carriage plates comprise a left side plate, a right side plate, a head plate, a soleplate, a front plate and a backdoor plate, wherein, injection groove full of high density polyurethane are formed by the notches between the carriage plates, notches are equipped at jointed sites of the left side plate, the right side plate, the head plate, the soleplate, the front plate, an injection groove is formed by the notches between the left side plate and the soleplate, an injection groove is formed by the notches between the left side plate and the head plate, an injection groove is formed by the notches between the left side plate and the front plate; an injection groove is formed by the notches between the right side plate and the soleplate, an injection groove is formed by the notches between the right side plate and the head plate, an injection groove is formed by the notches between the right side plate and the front plate; an injection groove is formed by the notches between the head plate and the front plate, an injection groove is formed by the notches between the soleplate and the front plate.

2. The carriage sealing structure for refrigerator car as claimed in claim 1, wherein inner overlockings are equipped at jointed sites of the left side plate, the right side plate, the head plate, the soleplate and/or the front plate of the carriage plates.

3. The carriage sealing structure for refrigerator car as claimed in claim 2, wherein external overlockings are equipped at jointed sites of the left side plate, the right side plate, the head plate, the soleplate and/or the front plate of the carriage plates.

4. The carriage sealing structure for refrigerator car as claimed in claim 3, wherein the inner overlockings and the external overlockings are connected and fasten to the carriage plate with the bolts or rivets.

5. A working method for the carriage sealing structure comprises the following steps:
Step A. Cutting out the notches at the jointed sites of the left side plate, the right side plate, the head plate, the soleplate and/or the front plate of the carriage, or forming the notches directly when the left side plate, the right side plate, and the head plate being foaming;
Step B. Assembling the left side plate, the right side plate, the head plate, the soleplate and the front plate together to form a carriage without backdoor plate, and assembling a backdoor frame at the back of the carriage;
Step C. First filling the polyurethane material into the injection grooves in the horizontal direction, as following:
Filling the polyurethane material into the injection groove formed by the notch equipped at jointed sites of the left side plate and the soleplate;
Filling the polyurethane material into the injection groove formed by the notch equipped at jointed sites of the left side plate and the head plate;
Filling the polyurethane material into the injection groove formed by the notch equipped at jointed sites of the right side plate and the soleplate;
Fill the polyurethane material into the injection groove formed by the notch equipped at jointed sites of the right side plate and the head plate;
Filling the polyurethane material into the injection groove formed by the notch equipped at jointed sites of the head side plate and the front side plate; and/or
Filling the polyurethane material into the injection groove formed by the notch equipped at jointed sites of the soleplate and the front side plate;
Step D. Then filling the polyurethane material into the injection grooves in the vertical direction, as following:
Filling the polyurethane material into the injection groove formed by the notch equipped at jointed sites of the left side plate and the front side plate; and/or
Filling the polyurethane material into the injection groove formed by the notch equipped at jointed sites of the right side plate and the front side plate.
Step E. Installing the backdoor plate to the backdoor frame.

6. The method as claimed in claim 5, wherein said step B), after assembling the carriage, adding inner overlockings and/or external overlockings
at jointed sites of the left side plate, the head plate and the soleplate;
at jointed sites of the right side plate, head plate and soleplate; and/or at jointed sites of the front plate, head plate and soleplate.

7. The method as claimed in claim 5, wherein after step C,
adding inner overlockings and/or external overlockings at jointed sites of the front plate, the left side plate and the right side plate.

8. The method as claimed in claim 6 and/or claim 7, wherein
the inner overlockings and the external overlockings are fasened onto the left side plate, the right side plate, the head plate, the soleplate and/or the front plate with bolts or rivets.

9. The method as claimed in claim 5, wherein in said step C) and step D) high density Polyurethane foam material is filled in the injection grooves in a high pressure.
